(19) United States
(12) Patent Application Publication
(10) Pub. No.: US 2010/0162840 A1
(43) Pub. Date: Jul. 1, 2010

(54) Double clutch gear change transmission

(76) Inventor: Carsten Gitt, Stuttgart (DE)

Correspondence Address: KLAUS J. BACH, 4407 TWIN OAKS DRIVE, MURRYSVILLE, PA, 15668, US

(21) Appl. No.: 12/655,070

(22) Filed: Dec. 22, 2009

Related U.S. Application Data
(63) Continuation-in-part of application No. PCT/EP2008/004640, filed on Jun. 11, 2008.

(30) Foreign Application Priority Data
Jun. 26, 2007 (DE) 10 2007 029634.9

(51) Int. Cl. F16H 3/08

(52) U.S. Cl. 74/330

(57) ABSTRACT

In a gear wheel speed change transmission with at least two power shift clutches, with gear wheels arranged in different gear wheel planes and with an input shaft and an output shaft, which can be actively interconnected by way of the gear wheels arranged in the gear wheel planes, which include at least six forward gears that can be shifted under power, all of the six forward gears, which are sequentially power-shiftable, and two reverse gears are formed by exactly six gear wheel planes and exactly three shift units with shift collars, which all have engagement positions at both sides of their neutral center position.

### BACKGROUND OF THE INVENTION

The invention relates to a double clutch gear change transmission with gear wheels arranged in gear planes for variably interconnecting a transmission input and a transmission output shaft via at least six forward gears which are shiftable sequentially under power by three shift units.

Gear change transmissions with at least two power shift clutches, with gear wheels arranged in gear planes and with an input shaft and an output shaft are already known, which can be interconnected under power by means of the at least two power clutches arranged in parallel in the power train and by means of the gears arranged in the gear wheel planes.

It is particularly the object of the present invention to provide a gear-wheel speed change transmission with a particularly high shift comfort and of a compact design.

### SUMMARY OF THE INVENTION

In a gear wheel speed change transmission with at least two power shift clutches, with gear wheels arranged in different gear wheel planes and with an input shaft and an output shaft, which can be actively interconnected by way of the gear wheels arranged in the gear wheel planes, which include at least six forward gears that can be shifted under power, all of the six forward gears, which are sequentially power-shiftable, and two reverse gears are formed by exactly six gear wheel planes and exactly three shift units with shift collars, which all have engagement positions at both sides of their neutral center position

“Sequentially power-shifted” gears is intended to mean that gears can shift from one gear to an adjacent gear without interrupting a power or torque transmission from the input shaft to the output shaft. To make this possible, adjacent gears respectively have to be assigned to different power shift clutches. “Adjacent gears” are meant to be gears which are arranged next to each other with regard to their transmission ratios. A particularly high shift comfort with a particularly compact design can be realized by a gear that can be shifted sequentially.

It is further advantageous if the six forward gears that can be sequentially power-shifted and two reverse gears can be formed by means of exactly six gear wheel planes and exactly three shift units or shift collars which can be shifted on both sides. Components, installation space and assembly costs can be reduced thereby.

It is further suggested that at least two gear wheel planes are formed as. input constants: Thereby, at least six forward gears which are shiftable sequentially under load can be provided in a simple manner. “Provided” is especially meant to be equipped, designed and/or programmed in a special manner. Further, “together” means that these gears are simultaneously used for the formation of a particular forward gear.

It is further suggested that the two gear wheel planes are provided together for forming at least one forward gear, and the one gear wheel plane serves as input constant in this forward gear and the other gear wheel plane serves for the transmission of the drive torque to the output shaft. The gear-wheel speed change transmission can thereby be of a particularly compact design.

It is further advantageous if a gear wheel plane is provided to form at least two differently transmitted forward gears in combination with one of the input constants. An advantageous shift behavior of the forward gears is achieved thereby.

In a further design of the invention, it is suggested that the gear-wheel speed change transmission comprises at least two differently transmitted reverse gears. An increased flexibility can be achieved thereby.

It is further suggested that the reverse gears are formed in that a gear wheel plane comprising a reversing unit can be operated in combination with a respective one of the input constants. The gear-wheel speed change transmission can thereby be designed in an even more compact manner.

It is particularly advantageous if also the reverse gears can be sequentially shifted under load, as the shift comfort is further increased thereby.

All step ratios from a second forward gear in the direction to higher forward gears are preferably formed with decreasing step ratios. A “step ratio” is especially meant to be the transmission ratio of a particular gear drive to a gear drive of the next higher gear. An advantageous transmission shifting can be achieved by such a progressive gear shift arrangement.

In an alternative embodiment, all step ratios from a second forward gear are formed partially in a decreasing manner and partially constant in the direction towards higher forward gears. A transmission shifting which is also advantageous can be achieved by such a virtually progressive gear shifting arrangement. In a further alternative embodiment, all step ratios between respectively two adjacent forward gears are formed in an approximately constant manner so that the shifting steps are all about the same. An advantageous transmission shifting can also be achieved by such a geometric gear shifting.

A control unit is further provided for shifting at least two gears in parallel and/or to separate them concurrently, of which one belongs to a group of even forward gears, and the other to a group of uneven forward gears. “Shifted in parallel” is meant especially to indicate that at least two gears are engaged simultaneously in the transmission by means of shift collars and the two power shift clutches respectively associated with the two forward gears are simultaneously operated in a slipping manner. By a parallel shifting of at least two gears, an increased power transfer, especially for a starting-up mode and/or an acceleration mode and/or an advantageous wear of the power shift clutches are achieved.

It is further suggested that the control unit is provided to choose and/or shift at least one gear in dependence on at least one characteristic value. The control unit can preferably shift in parallel at least two gears in at least a starting-up mode and subsequently choose, depending on at least one characteristic, which gear or which power shift clutch remains shifted or is closed completely, and which power shift clutch is opened. A characteristic value can thereby especially be formed by a load state characteristic and/or a road inclination characteristic and/or a necessary drive torque characteristic. A choice of the gears shifted by the control unit in dependence on the characteristic value is further feasible. It can thus be chosen if a first and a second forward gear or a second and a third forward gear are shifted for the starting-up. In an analogous manner, the previously described procedure can also be used for the parallel operation of two reverse gears with power shift clutches operated in a slipping manner and subsequent opening of one power shift clutch and complete closure of the other power shift clutch. An increased benefit to the driver and an increased comfort with an advantageously small dimensioning of the power shift clutches can be achieved by a correspondingly designed control unit.

The invention will become more readily apparent from the following description of a particular embodiment on the basis of the accompanying drawings. The drawing, the description and the claims contain numerous characteristics in combination.

### BRIEF DESCRIPTION OF THE DRAWINGS

FIG. 1 shows schematically a double clutch gear wheel speed clinge transmission, and

FIG. 2 shows the shift states of the gear wheel speed change transmission of FIG. 1.

### DESCRIPTION OF A PARTICULAR EMBODIMENT

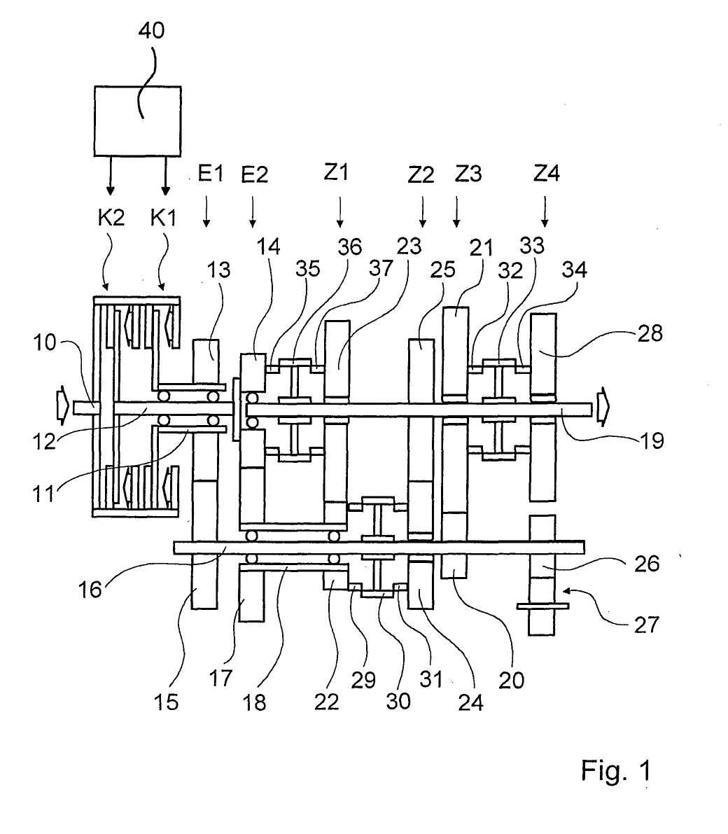

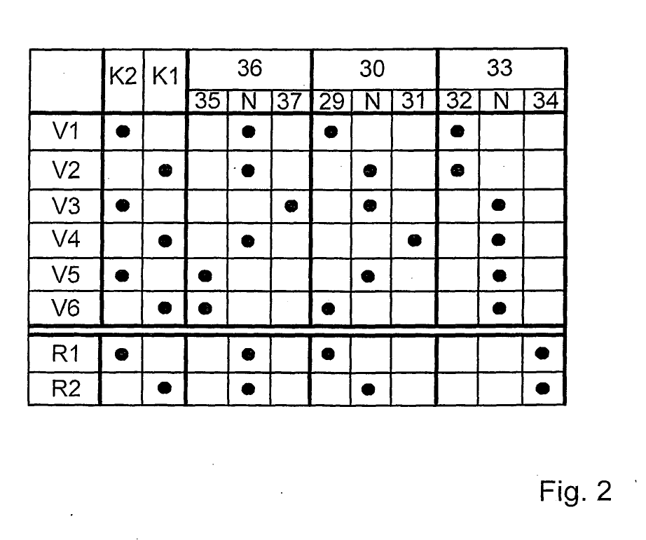

FIG. 1 shows schematically a gear-wheel speed change transmission according to the invention with six forward gears V1-V6 which can be sequentially shifted and two reverse gears R1, R2 (FIG. 2) which can also be sequentially shifted. The gear-wheel speed change transmission has an input shaft 10 which is connected to a first intermediate shaft 11 formed as a hollow shaft via a first power shift clutch K1. The first intermediate shaft 11 is concentric with a second intermediate shaft 12 and is mounted thereon. The second intermediate shaft 12 can be connected to the input shaft 10 via a second power shift clutch K2.

A fixed gear 13, 14 is respectively arranged on the intermediate shafts 11, 12. The fixed gear 13 on the first intermediate shaft 11 cogs with a fixed gear 15 on a first countershaft 16. The fixed gear 13 and the fixed gear 15 form a first input constant E1.

The fixed gear 14 on the second intermediate shaft 12 cogs with a fixed gear 17 on a second countershaft 18. The second countershaft 18 is formed concentrically to the first countershaft 16 which extends through the second countershaft 18. The second countershaft 18 is mounted rotatably on the first countershaft 16. The fixed gear 14 and the fixed gear 17 form a second input constant E2.

An output shaft 19 is connected to one end of a power train indicated by an arrow not shown in detail but indicted by an arrow at the output end thereof. With its other end, the shaft 19 is rotatably supported by the fixed gear 14 of the second intermediate shaft 12 by a suitable structure. The input shaft 10 and the output shaft 19 are coaxial to one another.

The input shaft 10 and the output shaft 19 can be connected to one another actively via six gear wheel planes E1, E2, Z1-Z4 for forming the six forward gears V1-V6 and the two reverse gears R1, R2. Two gear wheel planes are formed by the input constants E1, E2, which, together with the three further gear wheel planes Z1, Z2, Z3, are provided for forming the forward gears V1-V6, wherein one of these forward gears V5 is formed by the torque-proof connection of the intermediate shaft 12 to the output shaft 19. The sixth tooth wheel plane 24 is provided for forming the reverse gears R1, R2. The gear-wheel speed change transmission further comprises three shift units, which respectively comprise a shift collar 36, 30, 33 and respectively two clutch bodies 35, 37, 29, 31, 32, 34. The clutch bodies 35, 37, 29, 31, 32, 34 are provided to connect idler wheels 23, 24, 21, 28 to the shafts 16, 19 by means of the shift collars 36, 30, 33, on which shafts the idler wheels 23, 24, 21, 28 are arranged, in a torque-proof manner, or to connect the shafts 12 to 19 or 10 to 16 in a torque-proof manner.

The shift collars 36, 30, 33 are respectively fastened to the respective shafts 16, 19 in a torque-proof but axially displaceable manner.

A feature of the gear wheel shift transmission in principle is that a step ratio between the first and the second forward gear V1, V2 is identical to the step ratio between the fifth and sixth forward gear V5, V6.

A progressive gear shifting from the second forward gear V2 is also realized. Alternatively, a gear shifting can also be realized, where the step ratio between two adjacent forward gears is approximately the same.

The first and the second forward gears V1, V2 are formed via the gear wheel plane Z3. The gear wheel plane Z3 comprises a fixed gear 20 on the first countershaft 16, which cogs with the idler gear 21 on the output shaft 19. The first forward gear V1 has the transmission ratio 5.499, the second forward gear V2 3.948.

A third forward gear V3 is formed via the gear wheel plane Z1. The gear wheel plane Z1 has a fixed gear 22 fastened on the second countershaft 18, which cogs with an idler gear 23, which is supported on the output shaft 19. The third forward gear V3 has the transmission ratio 2.323.

A fourth forward gear V4 is formed via the toothed wheel plane Z2, which comprises the idler wheel 24 on the first countershaft 16, which cogs with a fixed wheel 25 on the output shaft 19. The fourth forward gear V4 has the transmission ratio 1.470.

A fifth forward gear V5 is a direct forward gear, where the input shaft 10 and the output shaft 19 are connected to one another in a torque-proof manner. The fifth forward gear V5 has the transmission ratio 1.000 as a direct gear.

A sixth forward gear V6 is formed via the input constants E1 and E2 and has the transmission ratio 0.725.

A first and a second reverse gear R1, R2 are formed via the toothed wheel plane Z4. The toothed wheel plane Z4 comprises a fixed gear 26 and a reversing unit 27, which comprises an intermediate wheel arranged in a torque proof manner on a separate shaft, and which is provided to form a rotational direction of the output shaft 19 opposed to the rotational direction of the forward gears V1-V6, and an idler wheel 28, which is arranged on the output shaft 19. The reversing unit 27 can alternatively comprise an intermediate gear mounted rotatably on a torque- proof axis.

For forming the first forward gear V1, the second countershaft 18 is connected to the first countershaft 16 via the clutch body 29 and the shift collar 30 in a torque-proof manner. Then the idler wheel 21 of the toothed gear plane Z3 is connected to the output shaft 19 via the clutch body 32 and the shift collar 33 in a torque-proof manner.

The second forward gear V2 is then already formed, as the first countershaft 16 is connected to the output shaft 19 via the gear wheel plane Z3, the clutch body 32 and the shift collar 33. The first and the second forward gear. V1, V2 are shifted in parallel in a starting-up mode by at least partially closing both power shift clutches K1, K2 by a control unit 40, which results in a slipping operation. The starting-up thus takes place in a primary phase simultaneously via the forward gears V1 and V2. Such a starting-up mode via both power shift clutches K1, K2 can particularly advantageously be used when the step ratio between the first forward gear V1 and the second forward gear V2 is comparatively small, thus for example smaller than the step ratio between the forward gears V2 and V3, as the difference in speeds which can be accommodated with the power shift clutches K1 and K2 operated in the slipping manner are comparatively small and thus excessive wear and/or excessive heat generation by particularly high frictional operations can largely be avoided in the power shift clutches K1 and K2.

Depending on one or several characteristics, as for example the load state of the vehicle, incline or decline of the road and drive torque provision by the driver vuia the position of the gas pedal, it is determined according to the previously described primary starting-up phase via the two forward gears V1 and V2 by the control unit 40, whether the drive performance shall be transmitted completely by the first forward gear V1 or by the second forward gear V2. For this, either the power shift clutch K2 is closed successively with simultaneous successive opening of the power shift clutch K1, or the power shift clutch K1 is closed successively with simultaneous successive opening of the power shift clutch K2.

For shifting from the first forward gear V1 to the second forward gear V2 under load, the control unit 40 shifts from the second power shift clutch K2 to the first power shift clutch K1 by closing the power shift clutch K1 with simultaneous successive opening of the power shift clutch K2. The shift collar 30 can subsequently be decoupled in a load-free manner.

For shifting to the third forward gear V3, the idler wheel 22 of the gear wheel plane 21 is connected to the output shaft 19 in a torque-proof manner via the clutch body 37 and the shift collar 36, which is secured to the output shaft 19 in a torque-proof but axially displaceable manner. The second countershaft 18 and the output shaft 19 are thereby connected to one another. For shifting from the second forward gear V2 to the third forward gear V3 under a load, The control unit 40 shifts from the first power shift clutch K1 to the second power shift clutch K2, by successively closing the power shift clutch K2 with simultaneous successive opening of the power shift clutch K1. The shift collar 33 can subsequently be decoupled in a load-free manner.

For forming the fourth forward gear V4, the first countershaft 16 is connected to the idler wheel 24 of the gear wheel plane Z2 in a torque-proof manner via a clutch body 31 and the shift collar 30. A connection to the output shaft 19 is thus made via the fixed wheel 25. For shifting from the third forward gear V3 to the fourth forward gear V4 under a load, the control unit 40 shifts from the second power shift clutch K2 to the first power shift clutch K1 by successively closing the power shift clutch K1 while simultaneously successively opening the power shift clutch K2. The shift collar 36 can subsequently be decoupled in a load-free manner.

The fifth forward gear V5 is established by connecting the fixed wheel 14 to the output shaft 19 via a clutch body 35 and the shift collar 36 in a torque-proof manner. A torque-proof connection of the second intermediate shaft 12 to the output shaft 19 exists thereby. So as to shift from the fourth forward gear V4 to the fifth forward gear V5 under load, the control unit 40 shifts from the first power shift clutch K1 to the second power shift clutch K2 by successively closing the power shift clutch K2 with a simultaneous successive opening of the power shift clutch K1. The shift collar 30 can subsequently be decoupled in a load-free manner.

The sixth forward gear V6 is established by connecting the first countershaft 16 to the second countershaft 18 via the clutch body 29 and the shift collar 30 in a torque-proof manner. The second countershaft 18 is connected to the output shaft 19 by the clutch body 35 and the shift collar 36. For shifting from the fifth forward gear V5 to the sixth forward gear V6 under a load, the control unit 40 shifts from the first power shift clutch K1 to the second power shift clutch K2 by successively closing the power shift clutch K1 with a simultaneous successive opening of the power shift clutch K2.

For forming both reverse gears R1, R2, the idler wheel 28 of the gear wheel plane Z4 is connected to the output shaft 19 via the clutch body 34 and the shift collar 33 in a torque-proof manner. The second reverse gear R2 is already established in this manner. For establishing the first reverse gear R1, the second countershaft 18 is also connected to the first countershaft 16 via the the clutch body 29 and the shift collar 30 in a torque-proof manner. As both reverse gears R1, R2 are then formed simultaneously, the two reverse gears R1, R2 can be switched under power themselves. With a suitable position of all shift collars 30, 33 36, one can shift between the two reverse gears R1, R2 by only changing between the power shift clutches K1, K2.

What is claimed is:

1. A gear wheel speed change transmission with at least two power shift clutches (K1,K2), with gear wheels arranged in gear wheel planes (E1, E2, Z-Z4) and with an input shaft (10) and an output shaft (19), which can be actively interconnected by way of the gear wheels arranged in the gear wheel planes (E1, E2, Z1-Z4), including at least six forward gears (V1-V6) that can be shifted under power, all of the six forward gears (V1-V6), which are sequentially power-shiftable, and two reverse gears (R1, R2) being formed by exactly six gear wheel planes (E1, E2, Z1, Z2, Z3, Z4) and exactly three shift units or shift collars (30, 33, 36), which all have engagement positions at both sides of their neutral center position.

2. The gear wheel speed change transmission according to claim 1, wherein at least two gear wheel planes (E1, E2) are formed as input constants.

3. The gear wheel speed change transmission according to claim 2, wherein the two gear wheel planes (E1, E2) are together provided for forming at least one forward gear (V6), and, in this forward gear (V6), one gear wheel plane (E1) serves as input constant, and the other gear wheel gear (E2) serves for transmitting the drive torque to the output shaft (19).

4. The gear wheel speed change transmission according to claim 2, wherein one gear wheel plane (Z3) is provided so as to form at least two differently transmitted forward gears (V1, V2) in combination with one of the input constants (E1, E2).

5. The gear wheel speed chande transmission according to claim 1, including at least two reverse gears (R1, R2) with different transmission ratios.

6. The gear wheel speed change transmission according to claim 5, wherein the reverse gears (R1, R2) are formed in that a gear wheel plane (Z4) comprising a reversing unit (27) is operable selectively in combination with either one of the input constants (E1, E2).

7. The gear wheel speed change transmission according to claim 5, wherein the reverse gears (R1, R2) are sequentially load shiftable.

8. The gear wheel speed change transmission according to claim 1, wherein all transmission steps from a second forward gear (V2) on have decreasing ratios in the direction towards higher forward gears (V2-V6).

9. The gear wheel speed change transmission according to claim 1, wherein all transmission steps from a second forward gear (V2) have partially decreasing ratios and partially the same ratios in the direction towards higher forward gears (V2-V6).

10. The gear wheel speed change transmission according to claim 1, wherein all step ratios between respectively two adjacent forward gears (V1-V6) are approximately constant.

11. The gear wheel speed change transmission according to claim 1, wherein a control unit (40) is provided for selectively connecting at least two gears (V1, V2), one of which belongs to the group of even numbered forward gears (V2, V4, V6), and another to the group of uneven numbered forward gears (V1, V3, V5), in parallel or separating them.

12. The gear wheel speed change transmission according to claim 11, wherein the control unit (40) is provided to choose and/or shift at least one gear (V1) depending on at least one characteristic.
